(19) United States
(12) Patent Application Publication
(10) Pub. No.: US 2018/0003068 A1
(43) Pub. Date: Jan. 4, 2018

(54) TURBINE ENGINE WHEEL

(71) Applicant: Safran Helicopter Engines, Bordes (FR)

(72) Inventors: Elena Collado Morata, Moissy-Cramayel (FR); Alban Prigent, Moissy-Cramayel (FR)

(73) Assignee: Safran Helicopter Engines, Bordes (FR)

(21) Appl. No.: 15/260,745

(22) Filed: Sep. 9, 2016

(30) Foreign Application Priority Data
Jun. 29, 2016 (FR) 1656115

(51) Int. Cl. F01D 11/00; F01D 5/02; F01D 5/12

(52) U.S. Cl. CPC F01D 11/006; F01D 5/12; F01D 5/02; F05D 2240/80; F05D 2220/30

(57) ABSTRACT

The invention relates to a wheel of a turbine engine comprising a plurality of radially extending vanes, one radially internal or external end of which is connected to an annular platform carrying annular lips (42, 44) extending from said platform in a direction opposite the vane in order to sealingly cooperate with a radially facing abradable material (28). According to the invention, the wheel comprises at least one lip (42, 44) having a concave curved upstream face and a convex curved downstream face or having a convex curved upstream face and a concave curved downstream face.

The invention relates to a wheel of a turbine engine, such as a turbine wheel, as well as turbine engine comprising such a wheel.

Conventionally, a turbine engine comprises a so-called primary annular air circuit and a so-called secondary annular circuit. The primary air circuit extends in the downstream direction through low and high pressure compressors, a combustion chamber and a high then a low pressure turbine.

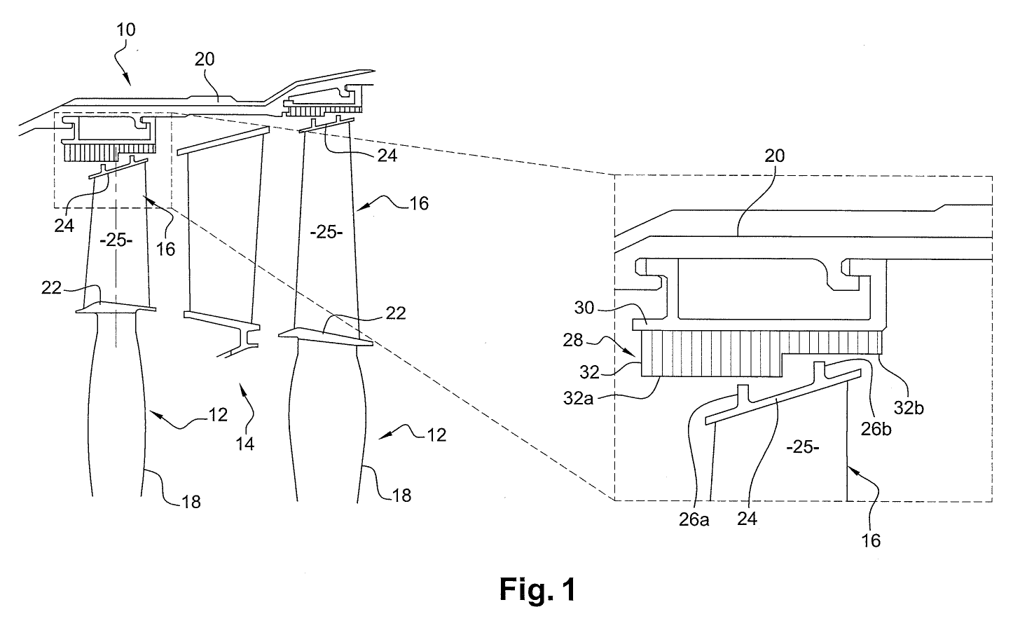

As shown in FIG. 1, the low pressure turbine 10 comprises a plurality of wheels 12 axially positioned so as to alternate with annular rows of stator vanes 14. The wheels 12 comprise vanes 16 carried by discs 18 integral with each other through the shaft of a low pressure turbine rotatingly driving the shaft of a fan or power shaft and the low pressure compressor. The vanes 14 of the stator are radially carried outwards by a casing 20 of the turbine.

More specifically, the right part of FIG. 1 shows the enlarged area defined by dots on the left part of the same figure. Each turbine wheel 12 comprises a radially internal annular platform 22 (FIG. 1) and a radially external annular platform 24 between which a vane 25 extends, with such platforms 22, 24 possibly consisting of a plurality of sections of plat-forms juxtaposed one after the other on the circumference to define the internal and external limits of the primary air flow. The external platform 24 comprises lips 26a, 26b radially extending outwards towards an abradable panel 28 carried by the turbine casing 20 and consisting of a wall 30 supporting an alveolar so-called honeycomb structure 32.

As can be seen in FIG. 1, the alveolar structure 32 may have two friction tracks 32a, 32b of the lips 26a, 26b, with a first one 32a being arranged upstream and radially inside a second one 32b arranged downstream from the first one 32a. In such a configuration, the upstream lip 26a thus extends over a distance radially smaller than the downstream lip 26b.

It could be noted that the sealing between the lips 26a, 26b and the tracks 32a, 32b of the abradable material 28 was not satisfactory. Thus, it has been provided lips sloping in the upstream direction between their internal and external ends. However, such lips are not totally satisfactory since unwanted air flow still remains between the abradable material and the radially external ends of the lips.

A need therefore exists to improve the sealing performances at this place in a turbine engine so as to increase the output of the turbine engine.

The invention makes it possible to provide a simple, economical and efficient solution to the problems of the prior art.

For this purpose, it provides a wheel of a turbine engine comprising a plurality of radially extending vanes, one radially internal or external end of which is connected to an annular platform carrying annular lips extending from said platform in a direction opposite the vane in order to sealingly cooperate with a radially facing ring, characterized in that it comprises at least one lip having a concave curved upstream face and a convex curved downstream face or having a convex curved upstream face and a concave curved downstream face.

According to the invention, a lip has two reverse curvatures on its opposed upstream and downstream faces. Such specific shape makes it possible to reduce the air flow between the opposite wall and the lip and thus makes it possible to enhance the efficiency of a turbine engine comprising such a wheel.

In a particular embodiment of the invention, the facing ring may be a simple smooth annular wall or a ring made of an abradable material as described while referring to the figures in the detailed description.

According to a specific characteristic of the invention, each lip has a first radial end connected to the plat-form and a second radial free end opposed to said first end, with said first end being arranged downstream from the second end

It has been noted that the tilt of the lip coupled to a shape with two curvatures of the upstream and downstream faces would make it possible to further reduce the unwanted air flow. Such effect is more particularly improved with a lip having a lip with a concave curved upstream face and a convex curved downstream face.

In one embodiment of the invention, the generatrix of the cone of revolution going through the first end and the second end is inclined relative to a plane perpendicular to the axis of the wheel by a value strictly greater than 0° and smaller than or equal to 60°, preferably between 15° and 45° and more preferably of the order of 30°.

According to another characteristic of the invention, the upstream and downstream faces of a lip have a substantially constant radius of curvature between the first end and the second end of a lip.

In one preferred embodiment of the invention, the lips radially extend outwards from an external annular platform.

All lips may have a concave curved upstream face and a convex curved downstream face or all have a convex curved upstream face and a concave curved downstream face.

In one possible embodiment of the invention, the wheel comprises another lip the upstream and downstream faces of which are substantially flat and mutually parallel, with the lip being radially oriented or inclined relative to a plane perpendicular to the axis of the wheel.

The invention also relates to a turbine of a turbine engine, such as a high pressure turbine, comprising at least one mobile wheel of the type disclosed above.

It also comprises turbine engine, such as a turboprop engine or a turbojet engine, comprising such a turbine.

The invention will be better understood other details, characteristics, and advantages of the invention will appear on reading the following description given by way of non-limiting example and with reference to the accompanying drawings, in which:

FIG. 1 already describe above, is a schematic sectional view of a low pressure turbine according to the prior art;

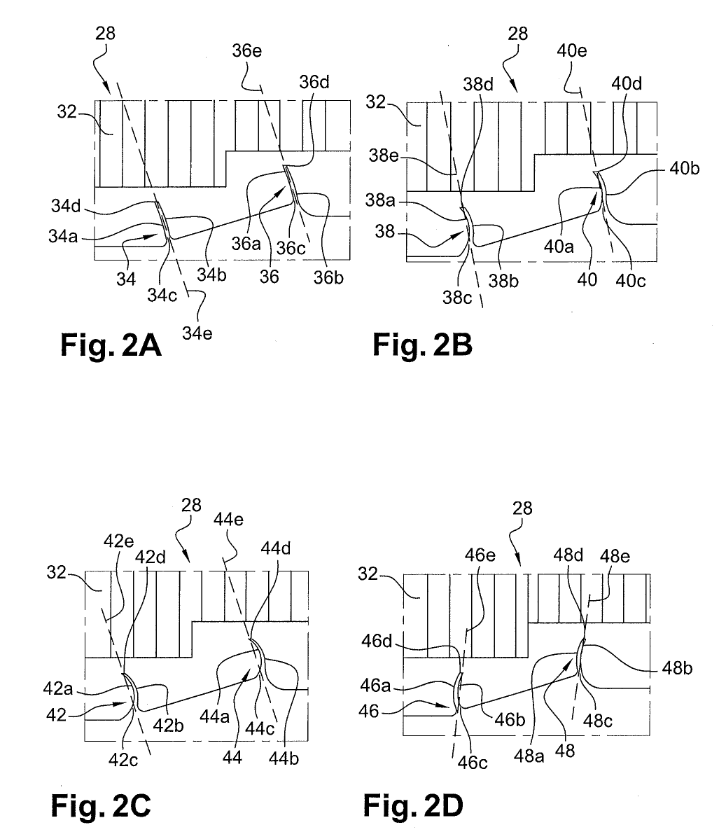

FIGS. 2A, 2B, 2C and 2D are schematic sectional views of the radially external end of a turbine wheel according to the invention and according to several alternative embodiments.

Reference is first made to FIGS. 2A, 2B and 2C which represent three first embodiments of the invention wherein the radially external end of the wheel comprises two annular lips 34, 36, 38, 40, 42, 44.

In such embodiments, the lips 34, 36, 38, 40, 42, 44 all comprise a curved concave upstream face 34a, 36a, 38a, 40a, 42a, 44a a convex curved face 34b, 36b, 38b, 40b, 42b, 44b. Each lip 34, 36, 38, 40, 42, 44, 46, 48 has a first radial end 34c, 36c, 38c, 40c, 42c, 44c connected to the platform and a second radial end 34d, 36d, 38d, 40d, 42d, 44d opposed to said first end 34c, 36c, 38c, 40c, 42c, 44c and forming a free end intended to sealingly rub the alveolar structure 32 of the abradable material 28 as already mentioned above.

When air impacts the upstream face 34a, 36a, 38a, 40a, 42a, 44a, the latter rotates clockwise, which tends to circulate air in the upstream direction and thus limits the circulations of air between the lip 34, 36, 38, 40, 42, 44 and the abradable material 28. Integrating a concave curved upstream face 34a, 36a, 38a, 40a, 42a, 44a and a convex curved downstream face 34b, 36b, 38b, 40b, 42b, 44b makes it possible to reduce the parasitic circulation of air between the abradable material 28 and the radially external ends 34d, 36d, 38d, 40d, 42d, 44d of the lips 34, 36, 38, 40, 42, 44 having a beneficial effect on the output, while limiting the boarded mass by using an optimized geometry of the lip.

The first end 34c, 36c, 38c, 40c, 42c, 44c of each lip 34, 36, 38, 40, 42, 44 is arranged downstream from the second end 34d, 36d, 38d, 40d, 42d, 44d, which makes it possible to further increase the air recirculation effect mentioned above. The axial shift of the first 34c, 36c, 38c, 40c, 42c, 44c and second 34d, 36d, 38d, 40d, 42d, 44d ends of the lips 34, 36, 38, 40, 42, 44 is shown in FIGS. 2A, 2B and 2C by the straight dotted lines 34e, 36e, 38e, 40e, 42e, 44e going through said ends of the lips 34, 36, 38, 40, 42, 44.

It should be noted that the curvatures of the upstream and downstream faces of the lips is more important for lips 42, 44 in FIG. 2C than for lips 38, 40 in FIG. 2B, with the latter having a more important curvature than that of the lips 34, 36 of FIG. 2A. It could be noted that the increased curvature resulted in a reduction in the parasitic air flow at the top of the lip. Independently of the variation in the slope of the lips, such effect can be seen between the FIGS. 2A and 2C wherein the lips 34, 36, 42, 44 have the same slope (the straight dotted lines 34e, 36e, 42e, 44e have the same slope relative to a plane perpendicular to the axis of the wheel), with the reduction in the parasitic flow being more important for the lips 42, 44 in FIG. 2C than for the lips 34, 36 in FIG. 2A.

The radius of curvature of the upstream 34a, 36a, 38a, 40a, 42a, 44a and downstream 34b, 36b, 38b, 40b, 42b, 44b faces of the lips 34, 36, 38, 40, 42, 44 may be substantially constant between the first end and the second end of a lip.

Preferably, the slope of the lips 34, 36, 38, 40, 42, 44 is such that the generatrix of the cone of revolution going through the first end 34c, 36c, 38c, 40c, 42c, 44c and the second end 34d, 36d, 38d, 40d, 42d, 44d is inclined relative to a plane perpendicular to the axis of the wheel by a value strictly greater than 0° and smaller than or equal to 60°, preferably between 15° and 45° and more preferably of the order of 30°.

FIG. 2D shows a last embodiment of the invention wherein the lips 46, 48 comprise a convex curved upstream face 46a, 48a, and a concave curved face 46b, 48b. In this embodiment, the first end 46c, 48c is arranged downstream from the second end 46d, 48d. The slope of each lip is shown by the dotted lines 46e, 48e.

In the embodiments shown in FIGS. 2A to 2D, all lips 34, 36, 38, 40, 42, 44, 46, 48 of the same platform end are identical. However, according to the invention, only one lip could be curved, with the other lip(s) then being straight, i.e. inclined relative to a plane perpendicular to the axis of the wheel or radially extending. The other lips can then have an upstream face and a downstream face which are substantially flat and mutually parallel.

In the embodiments described above, the lips 34, 36, 38, 40, 42, 44, 46, 48 have been presented as being annular. This of course should be understood as indicating that the lip annually extend over 360° and may consist of a plurality of sectors of lips juxtaposed one after the other on the circumference.

Although the invention has been disclosed above with respect to an abradable annular element, it should be understood that it can also be applied to any embodiment wherein the lip(s) sealingly cooperate with an annular part which may be smooth and which is not provided to specifically wear when in contact with the lips such as an abradable material.

1. A wheel of a turbine engine comprising a plurality of radially extending vanes, one radially internal or external end of which is connected to an annular platform carrying annular lips extending from said platform in a direction opposite the vane in order to sealingly cooperate with a radially facing ring, characterized in that it comprises at least one lip having a concave curved upstream face and a convex curved downstream face or having a convex curved upstream face and a concave curved downstream face.

2. A wheel according to claim 1, wherein each lip has a first radial end connected to the platform and a second radial end opposed to said first end, with said first end being arranged downstream from the second end.

3. A wheel according to claim 2, wherein the generatrix of the cone of revolution going through the first end and the second end is inclined relative to a plane perpendicular to the axis of the wheel by a value strictly greater than 0° and smaller than or equal to 60°, preferably between 15° and 45° and more preferably of the order of 30°.

4. A wheel according to claim 2, wherein the upstream and downstream faces of a lip have a substantially constant radius of curvature between the first end and the second end of a lip.

5. A wheel according to claim 1, wherein the lips radially extend outwards from an external annular platform.

6. A wheel according to claim 1, wherein all lips have a concave curved upstream face and a convex curved downstream face or all have a convex curved upstream face and a concave curved downstream face.

7. A wheel according to claim 1, further comprising another lip the upstream and downstream faces of which are substantially flat and mutually parallel, with the lip being radially oriented or inclined relative to a plane perpendicular to the axis of the wheel.

8. The turbine of a turbine engine, such as a high pressure turbine, comprising at least one mobile wheel according to claim 1.

9. A turbine engine, such as a turboprop engine or a turbojet engine, comprising a turbine according to claim 8.
